(19) United States
(12) Patent Application Publication
(10) Pub. No.: US 2003/0223551 A1
(43) Pub. Date: Dec. 4, 2003

(54) Method and system for exchanging and storing telephone messages

(76) Inventor: Oded Kafri, Beer Sheva (IL)

Correspondence Address: Daniel J Swirsky, Alphapatent Associates, PO Box 2345, Beit Shemesh, 99544, IL

(21) Appl. No.: 10/181,819

(22) PCT Filed: Jan. 24, 2001
(86) PCT No.: PCT/IL01/00070

(30) Foreign Application Priority Data
Jan. 24, 2000 (IL) 134190

(51) Int. Cl. H04M 11/00; H04M 1/64

(52) U.S. Cl. 379/88.13; 379/88.17; 379/88.14

(57) ABSTRACT

A method and system for exchanging and storing telephone messages is provided. The method includes the steps of a sender recording a message for an addressee at a first server (20) and the first server (20) converting the message to an attached file in e-mail format and sending the e-mail format message via the Internet to a second server (40). The second server (40) is located in the nearest local telephone code area of the addressee.

### FIELD AND BACKGROUND OF THE INVENTION

Voice mail supplied by PTT's (Postal, Telegraph and Telephone) and cellular carriers is generally stored in voice boxes. The popularity of these systems has grown dramatically with the great penetration of cellular telephone since the traditional home answering machine cannot work while the telephone is shut down. The technology used by the producers of the voice boxes for the telephone carriers, such as Comverse Technology, Inc., (Woodbury, Long Island, N.Y. USA), Brooktrout Technology Inc., (410 First Avenue, Needham, Mass. 02494-2722), etc., is based on a server containing a storage media, typically hard disks, in which each box owner has a specific location or address in which his/her messages are stored. While a new message (voice or fax) is stored, a notification to the telephone owner is given through the carrier switch either by a specific tone, which is heard when using the phone or, alternatively in cellular phones by sending a message using SMS (Small Message Standard) technology.

The main disadvantages of existing systems are;

1) To send a message so that it reaches the box in a short time is expensive and requires rather sophisticated switching; and

2) In order to retrieve a message, the caller has to communicate directly with his/her box, which may be involved in a long distance call national or international call if the owner is outside his local area or out of the country.

### SUMMARY OF THE INVENTION

The present invention provides a method and apparatus for sending voice and facsimile messages via the Internet.

There is thus provided in accordance with a preferred embodiment of the invention, a method and a system for exchanging and storing telephone messages is provided. The method includes the steps of a sender recording a message for an addressee at a first server and the first server converting the message to an attached file in e-mail format and sending the e-mail format message via the Internet to a second server. The second server is located in the nearest local telephone code area of the addressee.

The system includes a plurality of servers in communication with each other via the Internet. The plurality of servers include at least a first server for recording a message for an addressee from a sender and at least a second server. The second server is located in a different telephone code area from the first server. The first server converts the message to an attached file in e-mail format for sending to the second server.

Furthermore, in accordance with a preferred embodiment of the invention, further includes the steps of the second server storing the received message; and notifying the addressee of the receipt of the message and the telephone number of the sender.

Furthermore, in accordance with a preferred embodiment of the invention, the attached file is at least one of a group including a wave file, a compressed wave file and a TIF file.

Furthermore, in accordance with a preferred embodiment of the invention, the method further includes the step of identifying the sender from the calling telephone number.

Furthermore, in accordance with a preferred embodiment of the invention, the method further includes the step of the addressee retrieving the stored message from the second server. The step of retrieving includes the steps of identifying the person retrieving the message from the calling telephone number.

Alternatively, the step of retrieving includes the steps of requesting the person retrieving the message to enter the telephone number to which the notification was sent.

Furthermore, in accordance with a preferred embodiment of the invention, the method further includes the steps of the addressee recording a reply message for the sender at the second server; and the second server converting the reply message to an attached file in e-mail format and sending the e-mail format reply message via the Internet to the first server.

Furthermore, in accordance with a preferred embodiment of the invention, the method further includes the steps of the first server storing the reply message; and notifying the sender of the receipt of a reply message from the addressee.

Furthermore, in accordance with a preferred embodiment of the invention, the method further includes the step of the sender retrieving the stored message from the second server.

Furthermore, in accordance with a preferred embodiment of the invention, the message is a facsimile message. The step of retrieving includes the steps of identifying the facsimile machine person retrieving the facsimile message.

Furthermore, in accordance with a preferred embodiment of the invention, each of the plurality of servers includes a computer Telephone Integration (CTI) card, a converter in communication with the CTI card for converting messages to email format, a database for storing the messages, an e-mail server for sending the e-mail format message via the Internet to the second server; and a SMS (Small Message Standard) messager for notifying the addressee of the receipt of a message.

Furthermore, in accordance with a preferred embodiment of the invention, further includes an Internet web site associated with the plurality of servers. Each of the plurality of servers further includes a look-up table containing e-mail addresses associated with telephone numbers. Notification of the receipt of the message is sent to the email address associated with the addressee.

### BRIEF DESCRIPTION OF THE DRAWINGS

The present invention will be understood and appreciated more fully from the following detailed description taken in conjunction with the appended drawings, in which:

FIG. 1 is a is a schematic illustration of the system method for sending a voice and/or facsimile message, constructed and operative in accordance with a preferred embodiment of the present invention;

FIG. 2 is a flow chart illustration of the method for sending a voice message;

FIG. 3 is a flow chart illustration of the method of retrieving a voice message;

FIG. 4 is a flow chart illustration of the method for sending a facsimile message; and

FIG. 5, which is a flow chart illustration of the method of retrieving a fax message.

### DESCRIPTION OF THE PRESENT INVENTION

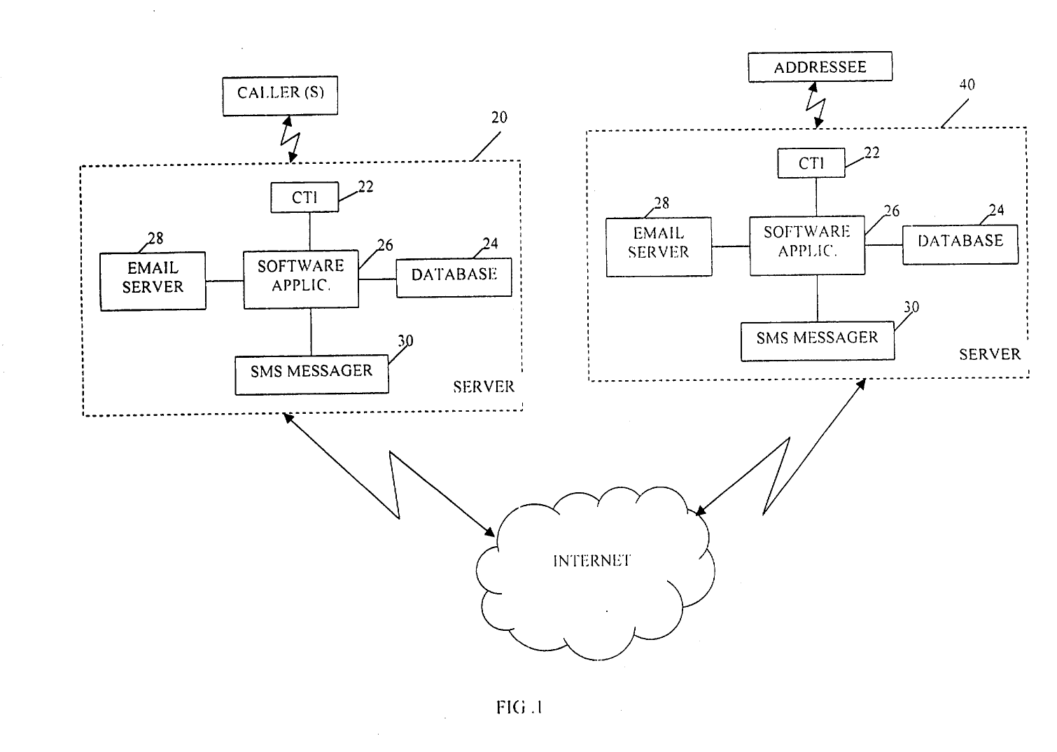

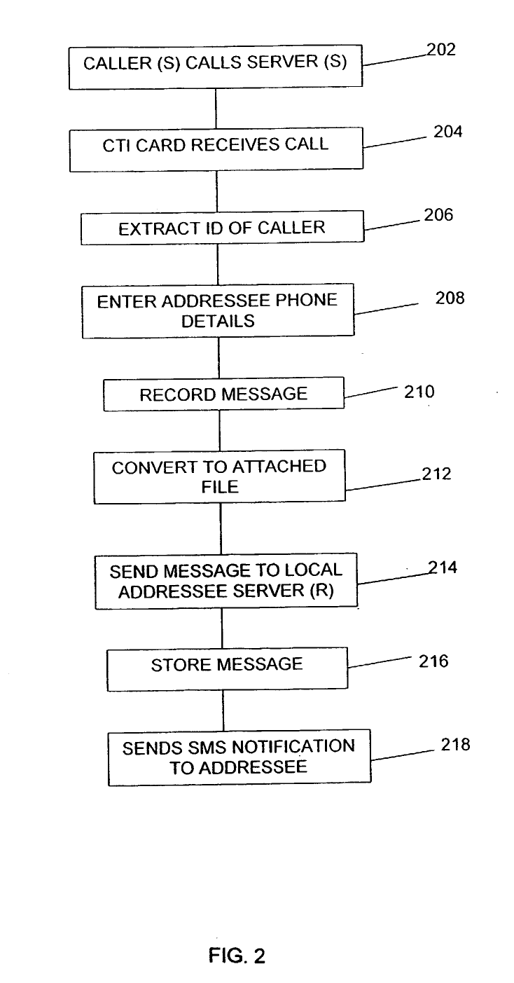

Reference is now made to FIGS. 1 and 2. FIG. 1 is a schematic illustration of the system and method for sending a voice and/or facsimile message, constructed and operative in accordance with a preferred embodiment of the present invention.

According to an embodiment of the present invention, the method is based on utilizing a plurality of servers, generally designated 20 and 40, which can exchange files. More specifically the servers exchange and store files using e-mail protocol with attached files.

Software for distributing and receiving files is commercially available, for example, “Exchange Server” by Microsoft Inc., (One Microsoft Way, Redmond, Wash. 98052-6339). Each server also contains a CTI (Computer Telephony Integration) card 22, which accepts the calls and converts the voice data into digital files, which can be stored and handled by computers in a regular say. An example of a CTI card which can be used with analogue systems is the “Dialogic card” No. VFX/40 ESC+, available from Dialogic 1515 Route Ten, Parsippany, N.J. 07054 USA. CTI cards convert analogous voice data into digital data. These cards usually have the caller ID function which can detect and register the telephone number from which the call was made.

In digital telephony, where VoIP (Voice over Internet Protocol) are used, CTI cards are not required, since the digital data is prepared in the handset itself.

The servers 20, 40 also contains a database 24, such as “SQL” by Microsoft Inc. or “Oracle” by Sun Microsystems, Inc. (901 San Antonio Road, Palo Alto, Calif. 94303 USA).

In addition, servers 20, 40 contains at least one software application, generally designated 26, that enable the caller to leave and retrieve messages. The server also includes an e-mail server 28, such as “Exchange” by Microsoft Inc. or any other suitable server. Preferably the e-mail server 28 should be capable of sending SMS textual messages to cellular telephones (which have been configured for SMS). SMS message servers 30 are available through several vendors, such as UNIMOBILE.COM, GOSMS.COM, IBM for example.

Reference is now made to FIG. 2 which is a flow chart illustration of the method for sending the message.

A caller S who wishes to leave a message, calls a focal server 20 (step 202), where the call is directed to the CTI card through the software application A (step 204) The CTI card extracts the ID (identification details) of the caller S (step 206).

The caller S is then requested to enter the destination telephone number, including area code and country code (if applicable) (step 208) for the message, after which the caller S is prompted the to record his voice message (step 210). If a fax is being sent, the caller is prompted to send his fax message (as will be described below).

The recorded voice message is then compressed as a standard compressed wave file (step 212).

The recorded message, along with the telephone number of the sender S, is preferably sent by e-mail server 28 through the Internet to the service server 40 located in the local area of the addressee R (step 214). “The local area” means the location in which the telephonic rate between the addressee and the server is the lowest.

The e-mail server 28 receives and sends e-mail and acts as an exchange server.

The message along with the telephone numbers of the sender S and the addressee R is stored in the database of server 40 (step 216). An SMS notification is sent by the software application located in server 40 to the telephone of the addressee R (step 218), to advise him that a voice/fax message has been received from S, and that it can be retrieved by dialing a dedicated telephone number associated with the server 40.

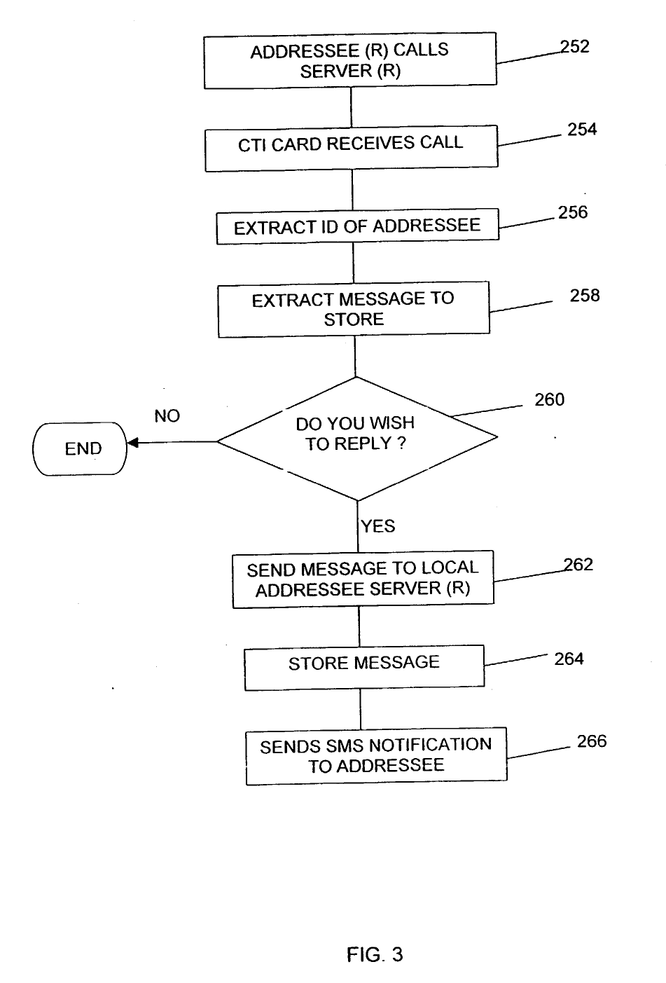

Reference is now made to FIG. 3, which is a flow chart illustration of the method of retrieving a voice message.

If the addressee R wishes to hear the voice message, he calls the dedicated telephone number associated with server 40 (step 252).

The call is directed to the CTI card through the software application B associated with retrieval of messages (step 254) The CTI card extracts the ID (identification details) of the caller S (step 256).

Software B can be reached by either allocating different lines to Software A and Software B, or by asking the caller if he wishes to send a message (in which case the caller is directed to Software A, as described above) or to retrieve a message.

Once the caller (retriever R) is identified through the caller ID, the messaged is extracted from the database and read for him (step 258).

At the end of the message, the retriever R has the option of replying (query box 260). If the retriever R wishes to record a reply message, the message is recorded (step 262) and forwarded to server 20 (originating the initial message) (step 264). Software A at server 20 then sends SMS notification to the sender S (step 266) (as described above—step 218).

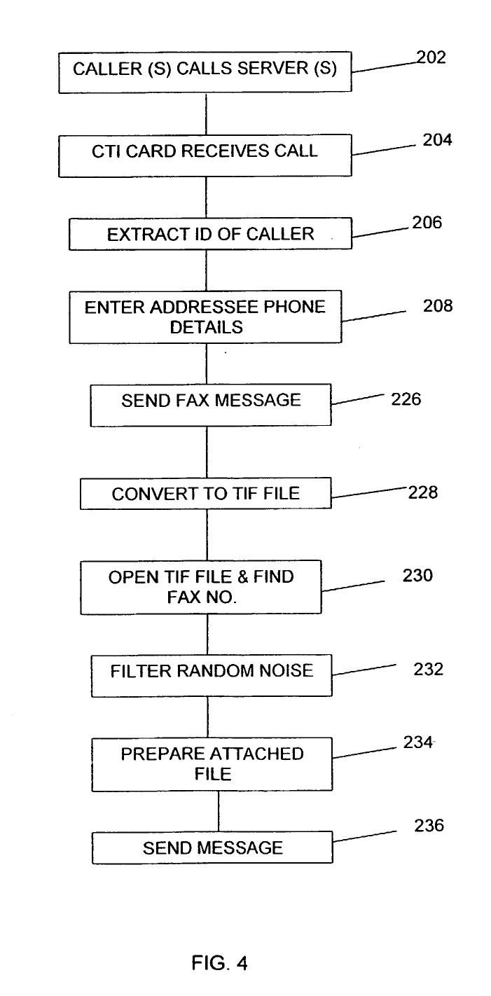

Sending a facsimile (Fax), which is illustrated with reference to FIG. 4, is similar to sending a voice message, described hereinabove with respect to FIG. 2, and similar reference numbers have been used for similar steps.

A caller S who wishes to leave a message, calls a local server 20 (step 202), where the call is directed to the CTI card through the software application A (step 204) The CTI card extracts the ID (identification details) of the caller S (step 206).

The caller S is then requested to enter the destination telephone number, including area code and country code (if applicable) (step 208) for the message, after which the caller S is prompted the to send the fax message (step 226).

The CTI card 22 converts the message to a TIF (Tagged Image File) file (step 228) instead of a compressed wave file (step 212).

The TIF file is then opened and the first page (or other page) having the addressee's facsimile number is accessed (step 230). Any random noise is filtered and the blank area of the first page ‘removed’ (step 232). An OCR (Optical Character Recognition) engine (not shown) is used to recognize the recipient fax number.

The Software A prepares an email message with an attached TIF file (step 234) and sends the message via the Internet to the service server 40 located in the local area of the addressee R (step 236 (similar to 214).

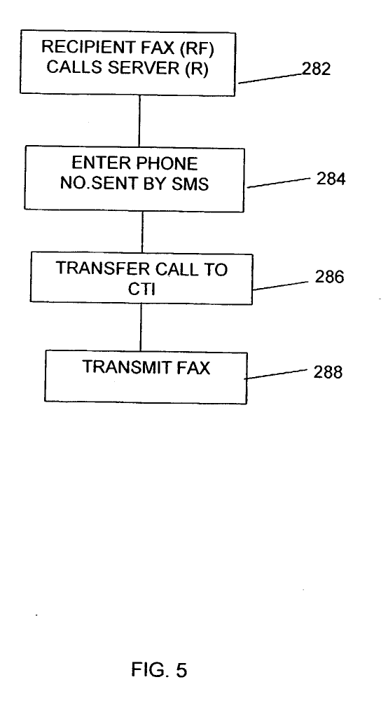

Reference is now made to FIG. 5, which is a flow chart illustration of the method of retrieving a fax message.

The recipient RF of the SMS notification that a fax has arrived, calls the server 40 from a fax machine using the telephone mode (step 282). The recipient RF is requested to dial the telephone number, to which the SMS was sent (step 284).

The call is directed to the CTI card through the software application B associated with retrieval of messages (step 286) The CTI card transmits the fax message to the fax machine of RF (step 288).

Thus, in contrast to the prior art, the present invention enables a person to leave a message for another person irrespective of the telephone carrier and without the necessity of using voice mail boxes.

In a further embodiment of the invention, the servers 20, 40 may be the “T-Mailer” servers, available from the Assignees of the present invention (Varicom Communications Ltd.). The T-Mailer service enables people to enter the database via the Internet and add their telephone number together with their e-mail addresses and their manes. Thus, the server can also send a copy of the message to the member's e-mail and give the sender's name in the SMS notification.

The T-Mailer server is similar to the proxy server described in PCT Patent Application: PCT/IL99/00516 assigned to the Assignees of the present invention. The T-mailer server generally comprises a Computer Telephone Integration (CTI) card connected to a wave API (Application Program Interface) and a message storage device. The server further comprises components such as a voice proxy telephone server and a transport provider for receiving and forwarding voice/text messages.

In another embodiment of the invitation, the call may be forwarded from the telephone of the retriever R when the line is busy or not answering to the nearest server.

Servers 20, 40 can be placed all over the world and enable one to send e-mail through out the world at the price of a local call.

It will be further appreciated that the present invention is not limited by what has been described hereinabove and that numerous modifications, all of which fall within the scope of the present invention, exist. Rather the scope of the invention is defined by the claims which follow:

1. A method of exchanging and storing messages, comprising the steps of:
a sender recording a message for an addressee at a first server; and
the first server converting the message to an attached file in e-mail format and sending the e-mail format message via the Internet to a second server, the second server being located in the local telephone code area of the addressee.

2. The method of claim 1, further comprising the steps of:
the second server storing the received message; and
notifying the addressee of the receipt of the message and the telephone number of the sender.

3. The method of claim 1, wherein the attached file is at least one of a group including a wave file, a compressed wave file and a TIF file.

4. The method of claim 1, further comprising the step of identifying the sender from the calling telephone number.

5. The method of claim 1, further comprising the step of the addressee retrieving the stored message from the second server.

6. The method of claim 5, wherein the step of retrieving comprises the steps of:
identifying the person retrieving the message from the calling telephone number.

7. The method of claim 5, wherein the step of retrieving comprises the steps of:
requesting the person retrieving the message to enter the telephone number to which the notification was sent.

8. The method of claim 5, further comprising the steps of:
the addressee recording a reply message for the sender at the second server; and
the second server converting the reply message to an attached file in e-mail format and sending the e-mail format reply message via the Internet to the first server.

9. The method of claim 8, further comprising the steps of:
the first server storing the reply message; and
notifying the sender of the receipt of a reply message from the addressee.

10. The method of claim 9, further comprising the step of the sender retrieving the stored message from the second server.

11. The method of claim 1, wherein the message is a facsimile message.

12. The method of claim 5, wherein the message is a facsimile message and wherein the step of retrieving comprises the steps of:
identifying the facsimile machine person retrieving the facsimile message.

13. A system for exchanging and storing messages, the system comprising:
a plurality of servers in communication with each other via the Internet, the plurality of servers comprising:
at least a first server for recording a message for an addressee from a sender; and
at least a second server, the second server being located in a different telephone code area from the first server;
wherein the first server converts the message to an attached file in e-mail format for sending to the second server.

14. The system of claim 13, wherein the attached file is at least one of a group including a wave file, a compressed wave file and a TIF file.

15. The system of claim 13, wherein each of the plurality of servers comprises:
a computer Telephone Integration (CTI) card;
a converter in communication with the CTI card for converting messages to email format;
a database for storing the messages;
an e-mail server for sending the e-mail format message via the Internet to the second server; and
a SMS (Small Message Standard) messager for notifying the addressee of the receipt of a message.

16. The system of claim 15, further comprising an Internet web site associated with the plurality of servers;
wherein each of the plurality of servers further comprises a look-up table containing e-mail addresses associated with telephone numbers; and
wherein notification of the receipt of the message is sent to the email address associated with the addressee.
